(19) United States
(12) Patent Application Publication
(10) Pub. No.: US 2011/0236750 A1
(43) Pub. Date: Sep. 29, 2011

(54) SECONDARY CELL AND METHOD OF PRODUCING SAME

(75) Inventors: Ryuji KOHNO, Mito (JP); Yutaka Sato, Hitachinaka (JP); Kouichi Kajiwara, Hitachinaka (JP); Mitsuru Koseki, Fukaya (JP)

(73) Assignee: Hitachi Vehicle Energy, Ltd.

(21) Appl. No.: 13/030,531

(22) Filed: Feb. 18, 2011

(30) Foreign Application Priority Data
Mar. 23, 2010 (JP) 2010-065413

(51) Int. Cl. H01M 2/08; H01M 2/30

(52) U.S. Cl. 429/181; 29/623.1

(57) ABSTRACT

A secondary cell of an embodiment of the present invention comprises: a cell case of a rectangular cuboid shape having an opening; a cell lid configured to seal the opening in the cell case; an electrode assembly provided in a space defined by the cell case and the cell lid; and an insulation cover configured to electrically insulate between the cell case and the electrode assembly. The insulation cover comprises: a bottom face part facing the opening in the cell case and having four sides; side face parts formed along at least two opposite sides of the four sides of the bottom face part; and bend parts provided in such a manner that boundaries between the bottom face part and the side face parts bend as the electrode assembly is inserted into the cell case.

### BACKGROUND OF THE INVENTION

1. Field of the Invention

The present invention relates to secondary cells (hereinafter also referred to simply as cells), as well as to a method of producing same.

2. Background Art

Given the social trend for global environmental protection, vehicle drive cells for hybrid vehicles, electric vehicles, etc., need to be put to practical and widespread use. There is known a structure for a vehicle drive cell wherein sheets of both a positive electrode and a negative electrode (i.e., positive and negative plates) as power-generating elements, a separator that separates the positive and negative plates, and an electrolyte are housed within a closed container made of a metal or resin, and wherein external terminals respectively coupled with both electrodes of the power-generating elements are provided.

Cells have hitherto and often been formed so as to be cylindrical in shape as viewed from the outside. However, in the case of vehicle batteries, in order to attain improved output and capacity, cells in quantities of several tens to upward of a hundred are put together and mounted on a single vehicle as an assembled battery. As such, cells of a prismatic shape (prismatic cells), which are advantageous in terms of packaging density, are beginning to be studied.

With respect to conventional prismatic cells, specific methods related to the present invention for electrically isolating (insulating) a cell case and an electrode assembly are known through, by way of example, the following documents.
Patent Document 1: JP Patent No. 4296522 B2
Patent Document 2: JP Patent No. 3413907 B2
Patent Document 3: JP Patent Publication (Kokai) No. 2009-170137 A
Patent Document 4: JP Patent Publication (Kokai) No. 2007-226989 A
Patent Document 5: JP Patent Publication (Kokai) No. 2005-302529 A

In Patent Document 1 mentioned above, a bag-like insulation film is disposed between a cell case and an electrode assembly.

In Patent Document 2 mentioned above, an electrode assembly is sandwiched by a leaf spring having a pair of spring leaves and that is formed by bending a continuous member of a single sheet, and is pressurized within the cell.

In Patent Document 3 mentioned above, an electrode assembly is covered with an insulation cover pre-formed in an unfolded form, and is housed within a cell case.

In Patent Document 4 mentioned above, an electrode assembly is covered with an insulation cover pre-formed in an unfolded form, and is housed within a cell case.

In Patent Document 5 mentioned above, the external face and the bottom face of a positive electrode are continuously covered in a U-shape with a sheet-shaped separator and negative electrode material, and these are housed within a cell case.

### SUMMARY OF THE INVENTION

The related art mentioned above respectively have the following problems. According to Patent Document 1, an insulation cover is pre-arranged in an unfolded form, and after a step in which bend parts are bent after an electrode assembly is placed therein and in which overlapping parts are then welded to form a bag-like shape (see paragraphs 0019 and 0020, as well as FIGS. 6 and 7 of Patent Document 1), these are housed within a cell case (see paragraphs 0026 and 0027, as well as FIGS. 8A through 8C of Patent Document 1). Thus, many steps are involved, resulting in higher costs, and, further, it is difficult to perform assembly without causing creases, twists, scratches, etc., in the insulation cover or the electrode assembly, or without causing the quality of the finished product to vary.

According to Patent Document 2, an electrode assembly and a resin material are covered from the outside with a stainless-steel material of a leaf-spring shape that exerts a compression force on the principal surface of the electrode assembly, and these are housed in a cell case (see paragraphs 0019 and 0020 of Patent Document 2). Thus, the stainless-steel material and the cell case rub directly against each other, and there is a possibility that the abraded metal dust produced thereby may enter the interior of the cell. This abraded dust needs to be prevented without fail as it significantly compromises the reliability of the cell. Further, since the stainless-steel material of a leaf-spring shape needs to be processed in advance to be bent into a predetermined shape by such methods as pressing, etc., there are many assembly steps for the cell, resulting in higher costs.

According to Patent Document 3 and Patent Document 4, an insulation cover that has been formed in an unfolded form is bent in advance into a predetermined shape, and an electrode assembly is then housed in the space thus formed (see paragraphs 0037 and 0038 of Patent Document 3, as well as paragraph 0014 and FIG. 3 of Patent Document 4). Thus, in the process of mass-producing cells, some instability is observed in the shape of the thin resin insulation cover after being bent, and it is difficult to house the electrode assembly favorably due to distortion, bending, etc. Further, since the electrode assembly is first housed in the insulation cover, and these are then housed in the cell case (see paragraph 0039 of Patent Document 3, as well as paragraph 0014 and FIG. 4 of Patent Document 4), it is difficult to align the electrode assembly, which is a layered structure of thin films, and the insulation cover, which also comprises a thin film, with respect to the cell case, and it is thus difficult to house them within the cell case.

According to Patent Document 5, because the bottom face of a positive electrode material is housed in a cell case after being covered in a U-shape with not only a separator but also a negative electrode material disposed on the external face thereof, the negative electrode and the cell case are placed in direct contact with each other. In other words, complete insulation between the electrode assembly, including the negative electrode material, and the cell case is difficult. Further, since the separator is of a U-shape, no insulation means is provided on the cell short side surfaces of the electrode assembly, and insulation is therefore difficult. In addition, since the positive electrode material, and the separator and negative electrode material that cover it in a U-shape form a unit in advance (see paragraph 0018 of Patent Document 5), they are inevitably formed first and then housed in the cell case, thereby making it difficult to house them favorably within the cell case for reasons similar to those provided above.

In view of the circumstances above, one problem the present invention seeks to address is to obtain a secondary cell that is cheap, for which the quality of finished products does not vary, and that is suited for mass-production.

In order to address the problem above, a secondary cell of the present invention comprises: a cell case of a rectangular cuboid shape having an opening; a cell lid configured to seal the opening in the cell case; an electrode assembly provided in a space defined by the cell case and the cell lid; and an insulation cover configured to electrically insulate between the cell case and the electrode assembly, wherein the insulation cover comprises: a bottom face part facing the opening in the cell case and having four sides; side face parts formed along at least two opposite sides of the four sides of the bottom face part; and bend parts provided in such a manner that boundaries between the bottom face part and the side face parts bend as the electrode assembly is inserted into the cell case.

According to the present invention, an insulation cover may be obtained from a simple sheet-shaped resin material without any three-dimensional molding using a dedicated resin casting mold. Thus, insulation cover production costs can be kept low, and the cost of the cell including the insulation cover can consequently be kept low.

### BRIEF DESCRIPTION OF THE DRAWINGS

FIG. 1A is a perspective view showing a production process for a cell of the first embodiment.

FIG. 1B is a perspective view showing a production process for a cell of the first embodiment.

FIG. 1C is a perspective view showing a production process for a cell of the first embodiment.

FIG. 1D is a perspective view showing a production process for a cell of the first embodiment.

FIG. 2A is a perspective view of an insulation cover of the first embodiment.

FIG. 2B is sectional view showing the state of an insulation cover of the first embodiment being housed in a cell case.

FIG. 3A is a perspective view of an insulation cover of the second embodiment.

FIG. 3B is a partial sectional view taken along line A-A, showing the state of an insulation cover of the second embodiment being housed in a cell case.

FIG. 4A is a perspective view of an insulation cover of the third embodiment.

FIG. 4B is a sectional perspective view showing the shape of an insulation cover of the third embodiment as housed within a cell case.

FIG. 5A is a perspective view of an insulation cover of the fourth embodiment.

FIG. 5B is a sectional perspective view showing the shape of an insulation cover of the fourth embodiment as housed within a cell case.

FIG. 6A is a perspective view of an insulation cover of the fifth embodiment.

FIG. 6B is a sectional perspective view showing the shape of an insulation cover of the fifth embodiment as housed within a cell case.

FIG. 7A is a perspective view of an insulation cover of the sixth embodiment.

FIG. 7B is a sectional perspective view showing the shape of an insulation cover of the sixth embodiment as housed within a cell case.

FIG. 8A is a perspective view of an insulation cover of the seventh embodiment.

FIG. 8B is a sectional view taken along line B-B, showing the state of an insulation cover of the seventh embodiment as housed in a cell case.

FIG. 9 is a perspective view showing the configuration of a spirally-wound body, which is an electrode assembly.

FIG. 10 is a perspective view showing the configuration of a layered body, which is an electrode assembly.

### DETAILED DESCRIPTION OF PREFERRED EMBODIMENTS

Embodiments of a cell to which the present invention is applied are described below.

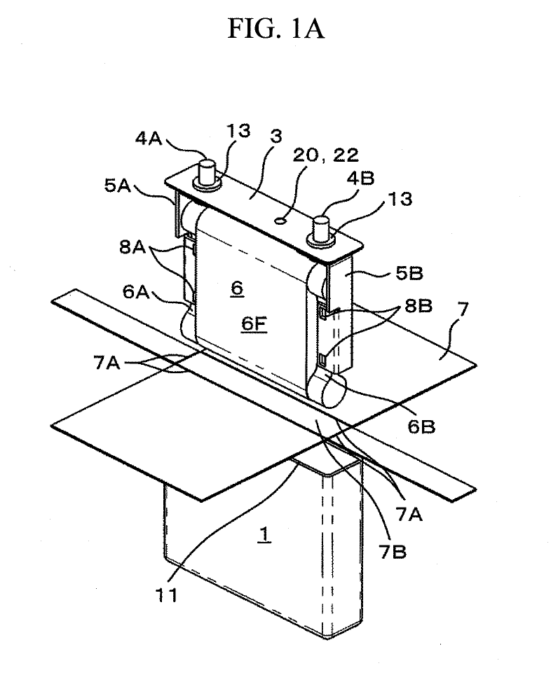

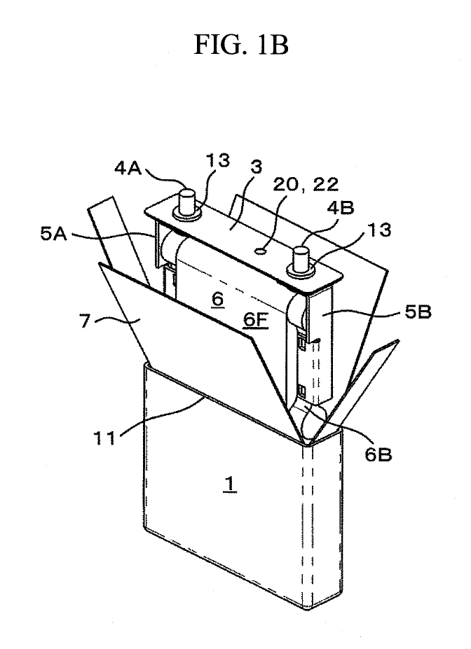

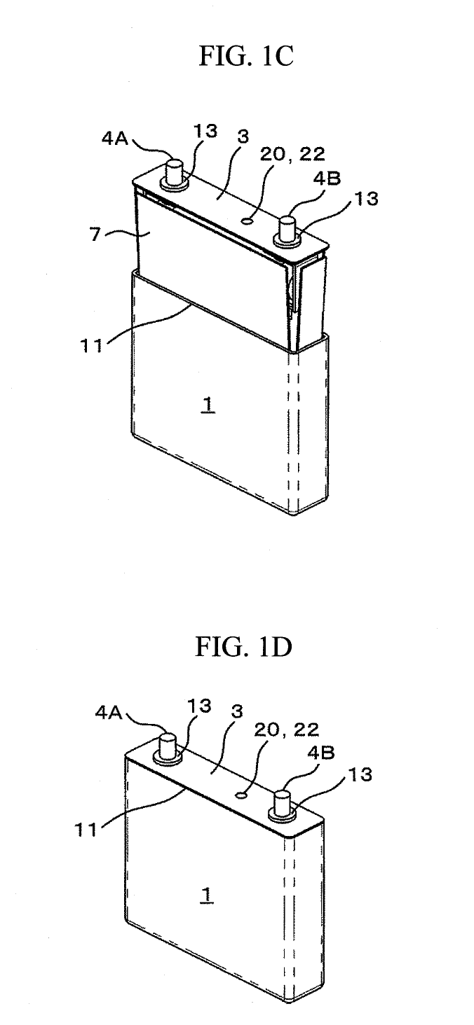

A cell of the present invention, as can be seen in FIG. 1A, comprises a generally rectangular cell case 1 with one face open, and a cell lid 3 that seals the open face (opening) 11 of the cell case 1. The cell lid 3 is formed in a planar shape with an outline that matches that of the open face 11 of the cell case 1. An aluminum alloy is used for both the cell case 1 and the cell lid 3.

Seal members 13, a connection plate 5A (positive electrode), a connection plate 5B (negative electrode), an external terminal 4A (positive electrode), and an external terminal 4B (negative electrode) are attached to the cell lid 3 by insertion through respective through-holes, and all of them are mechanically integrated with the cell lid 3. In addition, the connection plate 5A and the connection plate 5B are in direct contact with the external terminal 4A and the external terminal 4B, respectively, and are electrically conductive. An insulating resin, such as polyphenylene sulfide (PPS), polybutylene terephthalate (PBT), perfluoroalkoxy (PFA), etc., is used for the seal members 13. An aluminum alloy is used for the connection plate 5A and the external terminal 4A which serve as a positive electrode. A copper alloy is used for the connection plate 5B and the external terminal 4B which serve as a negative electrode.

An electrode assembly 6, in which a positive plate 6E, a negative plate 6D, and a separator 6C for polarity separation thereof are spirally wound together in a flattened shape, is placed inside the space defined by the cell case 1 and the cell lid 3 in a state where it is saturated with an electrolyte. The electrode assembly 6 is one in which the positive plate 6E and the negative plate 6D each having a collector foil are spirally wound or layered. At both ends, an uncoated part 6A (positive electrode) and an uncoated part 6B (negative electrode) are exposed, where no active material mix is applied over the collector foils of the positive and negative electrodes and the collector foils are exposed. The uncoated part 6A and the uncoated part 6B are located at mutually opposite sides in the electrode assembly 6. The connection plates 5A and 5B are disposed at one of the surfaces of the respective uncoated parts 6A and 6B, and are mechanically and electrically bonded at joints along with the uncoated parts 6A and the uncoated parts 6B, respectively, of the bundled layers. An ultrasonic bonding method is used for bonding. The uncoated part 6A and the uncoated part 6B are thinner than the coated part 6F of the positive plate 6E and the negative plate 6D coated with the active material mix by an amount corresponding to the thickness of the active material mix. Thus, as a result of bringing the layers close together through bonding, the overall thicknesses thereof are less than that of the coated part 6F.

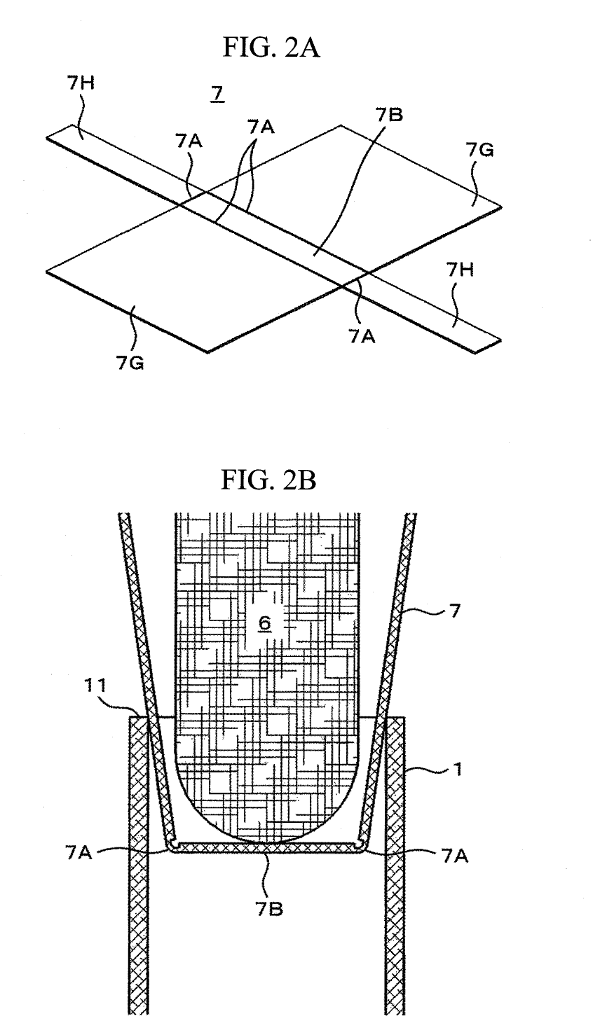

An insulation cover 7 that electrically insulates the electrode assembly 6 and the cell case 1 is disposed between the cell case 1 and the electrode assembly 6. The insulation cover 7 is in the form of a sheet, and as can be seen from FIG. 2A, its initial shape generally matches the unfolded form of the cell case 1. Generally linear thin parts 7A are formed at the boundaries between the faces. Polypropylene (PP), PPS, PBT, PFA, a composite material thereof, etc., is used for the insulation cover 7. The thin parts 7A are formed by performing a pressing process on a sheet-shaped resin material.

### <Production>

A cell is produced by way of: a preparatory step in which the seal members 13, the connection plate 5A, the connection plate 5B, the external terminal 4A, and the external terminal 4B are fixed with respect to the cell lid 3; an electrode formation step in which the positive plate 6E and the negative plate 6D are spirally wound and shaped to form the electrode assembly 6; a bonding step in which each layer of the uncoated part 6A and the uncoated part 6B of the electrode assembly 6 is placed in tight contact with the connection plates 5A and 5B and electrically and mechanically bonded; and a sealing step in which the electrode assembly 6 that has undergone the bonding step is housed in the cell case 1, and the cell case 1 and the cell lid 3 are bonded by welding. Each of these steps is described below.

### <Preparatory Step>

In the preparatory step, with respect to the cell lid 3 in which through-holes are provided, the seal members 13, the external terminal 4A, and the external terminal 4B are inserted into the respective through-holes. The tips of the inserted external terminal 4A and external terminal 4B on the inner side of the cell are passed through respective through-holes provided, in advance, in the connection plate 5A of the positive electrode and the connection plate 5B of the negative electrode, and these parts are crimped and fixed. Thus, the external terminal 4A and the external terminal 4B are placed in direct contact with the connection plate 5A and the connection plate 5B, respectively, and are thus placed in an electrically conductive state. Since the insulating seal members 13 are provided between these parts and the cell lid 3, they are in an electrically insulated state, and all are mechanically fixed. In order to improve the reliability of the electrical/mechanical coupling between the external terminal 4A and the connection plate 5A, as well as between the external terminal 4B and the connection plate 5B, the interface between the two at the crimped part may be further subjected to welding in some cases.

### <Electrode Formation Step>

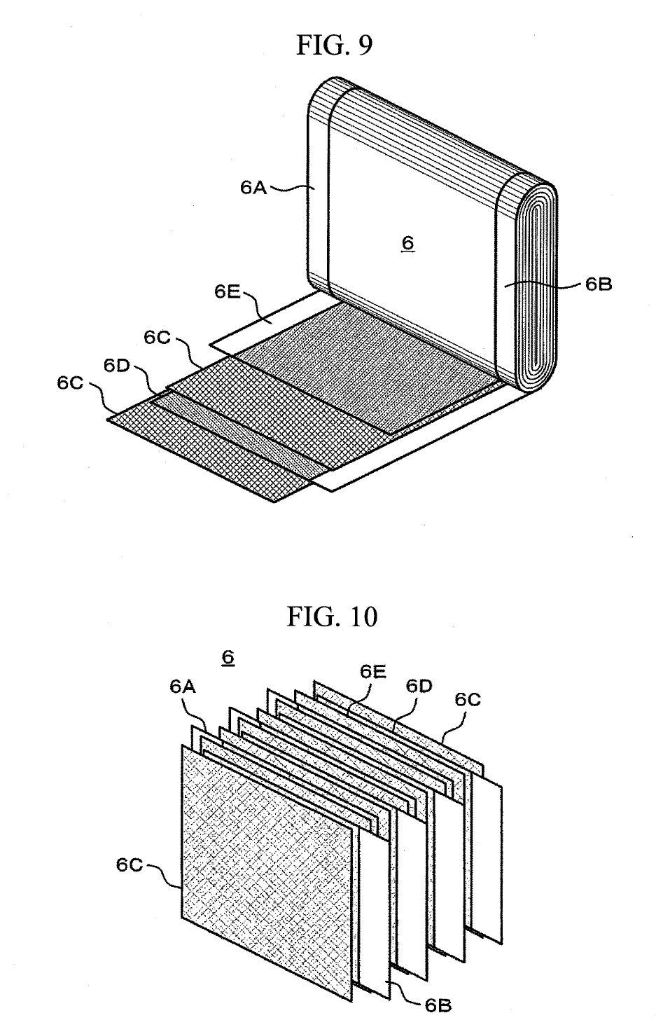

In the electrode formation step, the electrode assembly 6 is formed by spirally winding the positive plate 6E and the negative plate 6D with the separator 6C interposed therebetween. As shown in FIG. 9, the separator 6C, the negative plate 6D, the separator 6C, and the positive plate 6E are layered in this order, and are spirally wound from the negative electrode side in such a manner that the cross section would be oval-like. In so doing, the uncoated part 6A of the positive plate 6E and the uncoated part 6B of the negative plate 6D are so arranged as to be exposed on mutually opposite sides. Further, at the beginning and end of winding, just the separator 6C is wound two to three times to stabilize the shape.

For the positive plate 6E that forms the electrode assembly 6, an aluminum foil is used as a positive electrode collector foil. Both sides of the aluminum foil are coated with, in a generally even and uniform manner, a positive electrode active material mix including a lithium-containing transition metal multiple oxide, such as lithium manganate, etc., as a positive electrode active material. Besides the positive electrode active material, in the positive electrode active material mix are also mixed an electrically conductive material such as a carbon material, etc., and a binder such as polyvinylidene fluoride (hereinafter abbreviated as PVDF), etc. In coating the aluminum foil with the positive electrode active material mix, viscosity is adjusted with a dispersed solvent such as N-methylpyrrolidone (hereinafter abbreviated as NMP), etc. In so doing, the uncoated part 6A where the positive electrode active material mix is not applied is formed at a side margin at one of the longer sides of the aluminum foil. In other words, at the uncoated part 6A, the aluminum foil is exposed. After drying, the density of the positive plate 6E is adjusted through roll pressing.

On the other hand, for the negative plate 6D, a copper foil is used as a negative electrode collector foil. Both sides of the copper foil are coated with, in a generally even and uniform manner, a negative electrode active material mix including, as a negative electrode active material, a carbon material, such as graphite, etc, capable of reversibly occluding and discharging lithium ions. Besides the negative electrode active material, in the negative electrode active material mix are also mixed an electrically conductive material such as acetylene black, etc., and a binder such as PVDF, etc.

In coating the copper foil with the negative electrode active material mix, viscosity is adjusted with a dispersed solvent such as NMP, etc. In so doing, the uncoated part 6B where the negative electrode active material mix is not applied is formed at a side margin at one of the longer sides of the copper foil. In other words, at the uncoated part 6B, the copper foil is exposed. After drying, the density of the negative plate 6D is adjusted through roll pressing. It is noted that the length of the negative plate 6D is made greater than the length of the positive plate 6E so that when the positive plate 6E and the negative plate 6D are spirally wound, the positive plate 6E would not extend outside of the negative plate 6D in the winding direction at the innermost and outermost circumferences of the wind.

### <Bonding Step>

The partial assembly configured in the preparatory step and the electrode assembly 6 configured in the electrode formation step are prepared, and the two are aligned. Then, each layer of the uncoated part 6B is gathered towards the center portion of the electrode assembly 6 in the thickness direction and placed in tight contact with each other. Further, the connection plate 5A and the connection plate 5B are placed in contact with the outermost surface, pressurized, and subjected to ultrasonic vibration, thereby bonding each layer of the uncoated part 6B, the connection plate 5A, and the connection plate 5B all at once. Thus, the electrode assembly 6, the external terminal 4A, and the external terminal 4B are electrically and mechanically bonded via the connection plate 5A and the connection plate 5B. The above are performed both on the positive electrode side and the negative electrode side.

### <Sealing Step>

First, a structure that has undergone the preparatory step and the bonding step, the insulation cover 7, and the cell case 1 are arranged in the manner shown in FIG. 1A. In so doing, the insulation cover 7 is so aligned that its bottom face 7B falls entirely within the area of the open face 11 of the cell case 1, and the electrode assembly 6 is so aligned that its projection onto the insulation cover 7 falls within the bottom face 7B of the insulation cover 7. From this state, the electrode assembly 6 (as well as the various parts integrated therewith) or the cell case 1 is moved relative to the other in such a direction that the distance therebetween becomes smaller. It is not specified herein which of the electrode assembly 6 and the cell case 1 is to be moved. As this relative movement is continued past the moment at which the insulation cover 7 comes into contact with both the electrode assembly 6 and the cell case 1, the electrode assembly 6 is gradually inserted into the cell case 1 as shown in FIG. 1B, along with which the insulation cover 7 bends at the thin parts 7A. As the relative movement progresses further to the state shown in FIG. 1C, the insulation cover 7 takes on a three-dimensional shape following the inner faces of the cell case 1, while at the same time interposing itself between the respective parts of the electrode assembly 6 and the cell case 1 that face each other. In this state, the insulation cover 7 is such that mostly the thin parts 7A, which have less flexural rigidity than do their surrounding parts, bend as shown in FIG. 2B, and the other parts maintain a generally flat surface. Further, forming the thin parts 7A by introducing notches in the surface of the insulation cover 7 facing the power-generating element allows for smooth insertion without the problem of being caught by the edges of the opening in the cell case 1, which may happen if the thin parts 7A were formed by introducing notches in the surface on the opposite side, for example. The cell case 1 and the cell lid 3 ultimately come into contact with each other as shown in FIG. 1D, and the electrode assembly 6 is completely housed.

As described above, the insulation cover 7 is of such a structure that it bends at the thin parts 7A. Specifically, the insulation cover 7 comprises: the bottom face 7B (bottom face part) that faces the open face 11 (opening) of the cell case 1 and has four sides; two long side faces 7G and two short side faces 7H (collectively referred to as side face parts) that are formed along the four sides of the bottom face part; and bend parts provided so that the boundaries between the bottom face part and the side face parts would bend as the electrode assembly 6 is inserted into the cell case 1.

Next, the perimeters of the cell lid 3 and the cell case 1 are aligned, and pressure is applied by means of a jig so that there is no gap at the plane of alignment. Next, a laser beam is emitted towards the plane of alignment at the perimeters of the cell lid 3 and the cell case 1, scanning the entire perimeter along the plane of alignment, and thereby welding the cell case 1 and the cell lid 3.

Then, the electrolyte is filled through a filling port 20. In the present example, a nonaqueous electrolyte in which a lithium salt, such as lithium hexafluorophosphate (LiPF₆), etc., is dissolved in a carbonate ester organic solvent, such as ethylene carbonate, etc., is used for the electrolyte. In order to evenly and efficiently impregnate the power-generating element with the electrolyte down to its inner portion, the internal pressure of the cell case 1 is preset so as to be lower relative to the pressure on the outer circumference of the cell. After filling, the filling port 20 is plugged with a filling plug 22, and the outer circumference of the plane of alignment of the filling port 20 and the filling plug 22 is laser beam welded to form an airtight seal.

### (Working Effects, Etc.)

Next, working effects, etc., of a cell of the present embodiment are described.

[1] With a cell of the present embodiment, the insulation cover 7 can be obtained from a simple sheet-shaped resin material without any three-dimensional molding using a dedicated resin casting mold. Thus, production costs for the insulation cover 7 can be reduced and, consequently, the cost of a cell employing the insulation cover 7 can be reduced.

[2] With a cell of the present embodiment, in the sealing step, the insulation cover 7 is automatically folded to a predetermined three-dimensional shape by the relative change in distance between the electrode assembly 6 and the cell case 1. Thus, the electrode assembly 6 and the insulation cover 7 can be housed in the cell case 1 without requiring any special jig, and it is possible to reduce cell production costs.

[3] With a cell of the present embodiment, in the sealing step, the electrode assembly 6 can be housed in the cell case 1 while each face of the interposed insulation cover 7 on the side of the cell case 1 slides against the edges of the open face 11 of the cell case 1, and while the faces on the opposite side to the sliding faces are in tight contact with the surface of the electrode assembly 6 without sliding thereagainst. Thus, it is possible to prevent the electrode assembly 6 from being damaged by the edges of the open face 11 of the cell case 1. Further, since the insulation cover 7 gradually narrows its angle as the electrode assembly 6 enters the cell case 1, the electrode assembly 6 can be housed with ease even when its apparent thickness is greater than the opening width of the cell case 1.

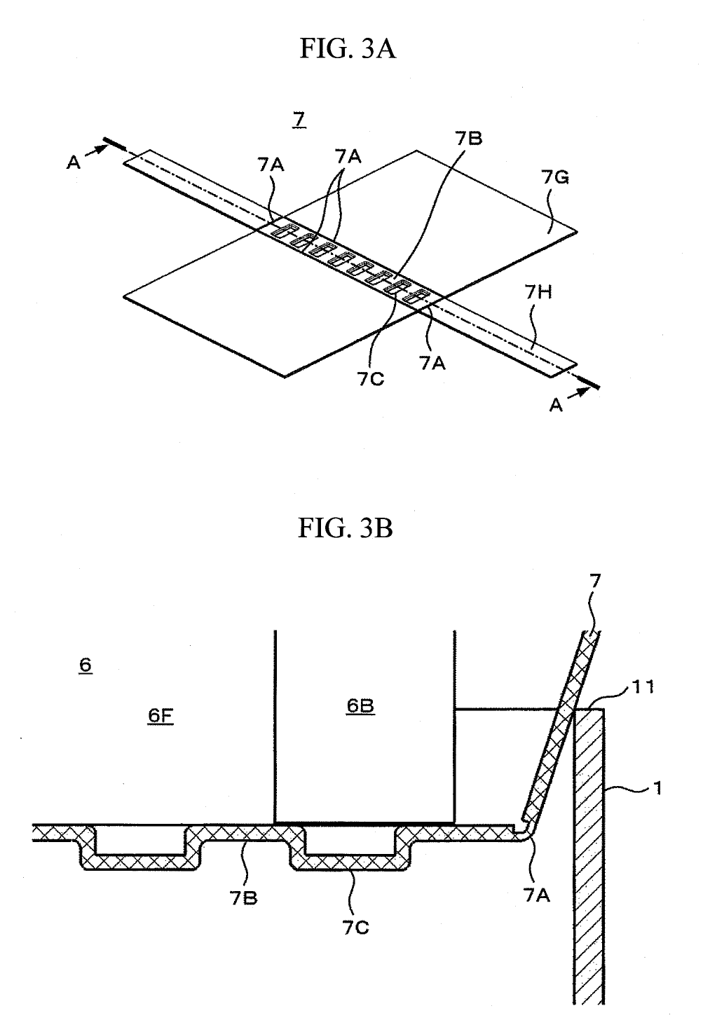

Next, FIG. 3A is a perspective view of the insulation cover 7 of the second embodiment, and FIG. 3B is a sectional view taken along line A-A showing a state of the insulation cover 7 as it is being housed in the cell case 1.

In the present embodiment, bump/dent parts 7C are provided on the bottom face 7B of the insulation cover 7. In the present invention, since the load required for the thin parts 7A of the insulation cover 7 to bend acts directly on the electrode assembly 6 as a compressive load, in order to suppress local deformation and prevent damage by distributing the stress experienced by each part of the electrode assembly 6, it is necessary for the bottom face 7B of the insulation cover 7 to not bend and to maintain a flat surface. By virtue of the bump/dent parts 7C, the flexural rigidity of the bottom face 7B improves relative to the first embodiment, and the difference in flexural rigidity between the bottom face 7b and the thin parts 7A becomes even greater As a result, it is possible to keep deformation of the bottom face 7B at the time of insertion into the cell case 1 low. Thus, it is possible to prevent damage to the electrode assembly 6.

It is noted that, in FIG. 3B, since there is adopted for the thin parts 7A a configuration in which part of the surface that faces the electrode assembly 6 is recessed, there is an effect whereby the places where the thin parts 7A are located are readily bendable.

It is noted that an object of the present embodiment, as mentioned above, lies in the relative improvement of the flexural rigidity of the bottom face 7B of the insulation cover 7 and that, as such, the form is by no means limited to that shown in the drawings, and various configurations may be employed, such as making only the bottom face 7B thick, combining a different material with a high Young's modulus, etc., for example.

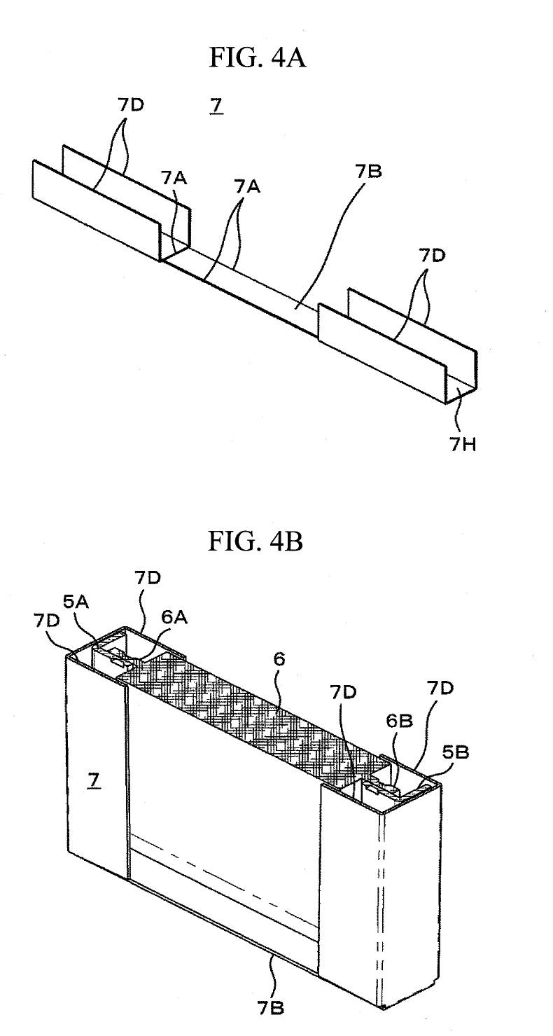

Next, FIG. 4A is a perspective view of the insulation cover 7 of the third embodiment, and FIG. 4B is a sectional view of a cell with the cell case 1 omitted.

In the present embodiment, the insulation cover 7 is without faces that face the surface of the coated part 6F of the electrode assembly 6. On the other hand, faces that face the connection plates 5A and 5B are processed and formed in advance in a three-dimensional shape with ribs (walls) 7D at both ends. As can be seen from FIG. 4B, after being folded and housed in the cell case 1, the insulation cover 7 only covers between the connection plates 5A, 5B and the cell case 1, and between the uncoated parts 6A, 6B and the cell case 1. As described in connection with the <electrode formation step>, the surface of the coated part 6F of the electrode assembly 6 is covered with the insulating separator 6C, thereby securing insulation from the outside. Where the margin of insulation by the separator 6C is sufficient, the shape of the insulation cover 7 may be simplified in the manner above, adopting a configuration in which it covers only between the connection plates 5A, 5B and the cell case 1 and between the uncoated parts 6A, 6B and the cell case 1, where no other insulation means is present. Through the present embodiment, the volume of the insulation cover 7 is reduced, thereby making it lighter. Consequently, the cell is made lighter. With respect to the ribs 7D, there are cases where they are formed by bending a sheet-shaped resin material in advance, as well as cases where the insulation cover 7 as a whole is formed by resin cast molding with which any shape can be obtained without the use of a sheet-shaped material.

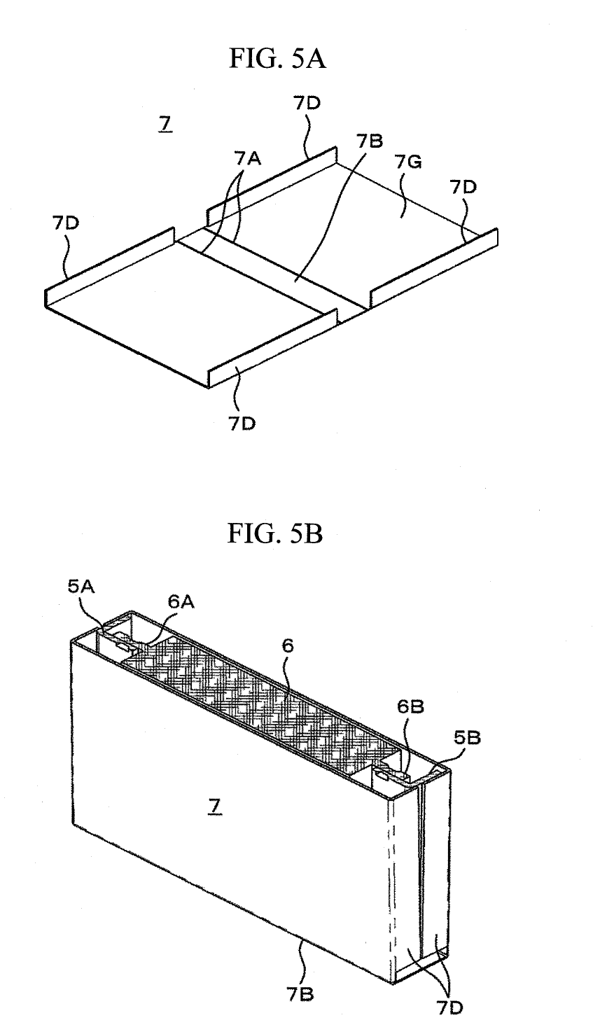

Next, FIG. 5A is a perspective view of the insulation cover 7 of the fourth embodiment, and FIG. 5B is a sectional view of a cell with the cell case 1 omitted.

In the present embodiment, the insulation cover 7 has the ribs 7D formed at both ends of each of the two faces that face the coated part 6F of the electrode assembly 6. As can be seen from FIG. 5B, once the insulation cover 7 is folded and housed in the cell case 1, the ribs 7D extend towards the connection plates 5A, 5B. Consequently, the insulation cover 7 is present at all of the interfaces between the cell case 1 and the power-generating element array 6. The ribs 7D may be provided in a similar manner to that mentioned in connection with the third embodiment.

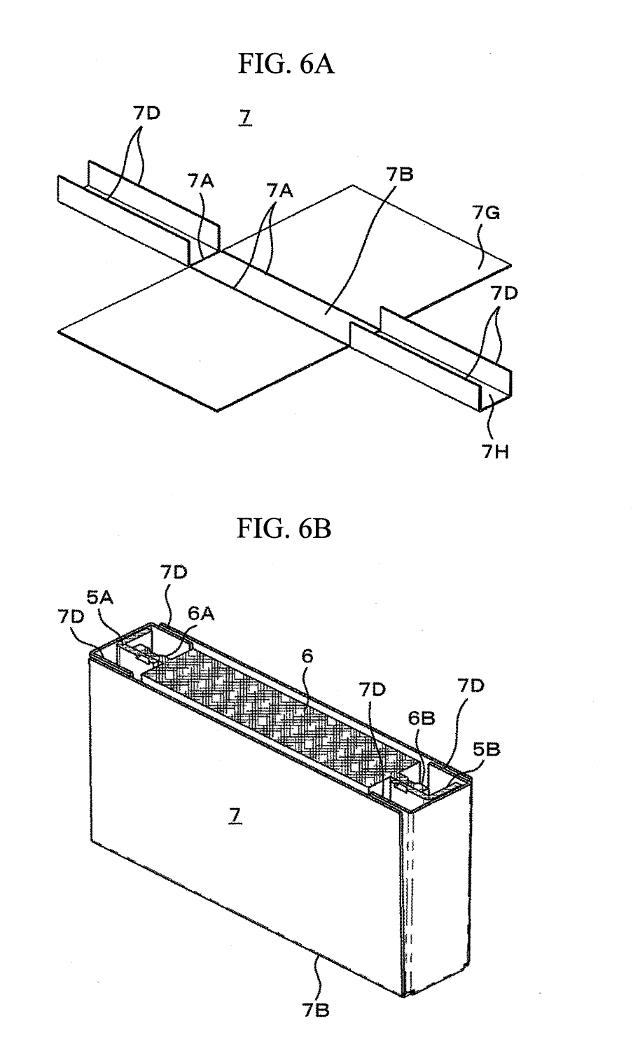

Next, FIG. 6A is a perspective view of the insulation cover 7 of the fifth embodiment, and FIG. 6B is a sectional view of a cell with the cell case 1 omitted.

In the present embodiment, as can be seen from FIG. 6A, the ribs 7D are provided in advance on the short side faces 7H of the insulation cover 7, the ribs 7D being perpendicular to the faces. As can be seen from FIG. 6B, once the insulation cover 7 is folded and housed in the cell case 1, the parts where the ribs 7D are provided are such that two layers of the insulation cover 7 overlap, as a result of which the slight gaps that were seen in the previous embodiments between adjacent folded faces of the insulation cover 7 are eliminated. Since, by way of the present embodiment, the gaps between the long side faces 7G and the short side faces 7H of the insulation cover 7 (i.e., the corner parts of the cell case 1) are eliminated, it is possible to prevent, by way of example, such problems as foil pieces, etc., partially sticking out from each layer of the uncoated part 6A and the uncoated part 6B entering the gaps to come into contact with the cell case 1 and so forth, and it is possible to make the insulating effect more reliable.

This configuration where two layers of the insulation cover 7 overlap is one in which the ribs 7D (walls) that are generally perpendicular to the short side faces 7H are provided at parts of the short side faces 7H, and walls are present between the short side faces 7H and the cell case 1. Since, by way of the present embodiment, another face of the insulation cover 7 overlaps on a side closer to the cell case 1 than is the rib 7D, it is possible to smoothly house the electrode assembly 6 and the insulation cover 7 in the cell case 1 without getting the ribs 7D caught by the open face 11 of the cell case 1 in the housing process.

Further, although, in FIGS. 6A and 6B, the ribs 7D are provided on the short side faces 7H, the ribs 7D may be provided only on the long side faces 7G instead of the short side faces 7H. In this case, too, it is possible to have walls be present between the long side faces 7G and the cell case 1, and effects similar to those above are attainable.

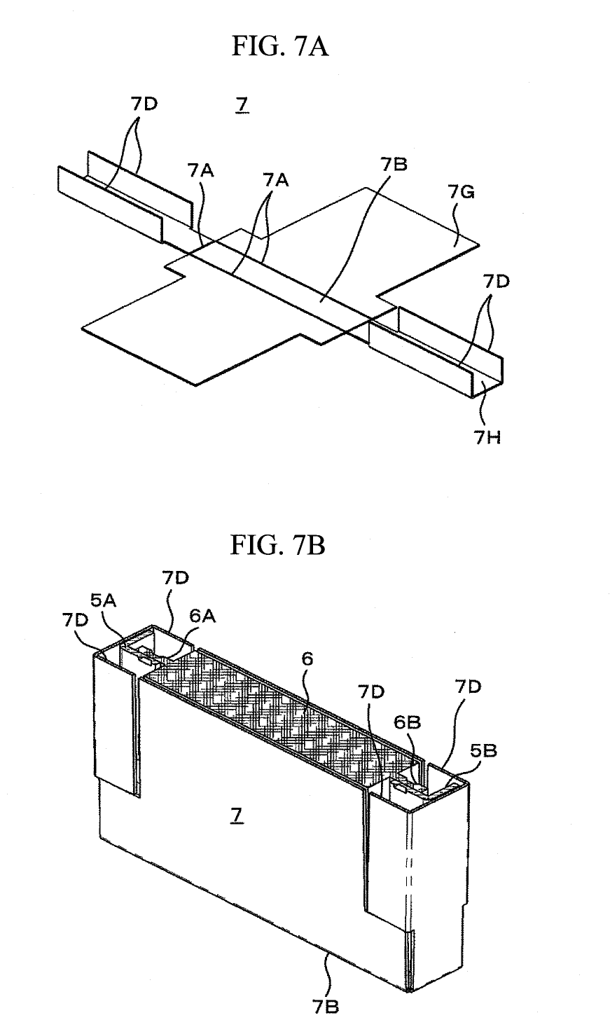

Next, FIG. 7A is a perspective view of the insulation cover 7 of the sixth embodiment, and FIG. 7B is a sectional view of a cell with the cell case 1 omitted.

In the present embodiment, as can be seen from FIG. 7A, the ribs 7D are provided partially on the short side faces 7H of the insulation cover 7, while the long side faces 7G are of a shape that is partially cut away. As can be seen from FIG. 7B, once the insulation cover 7 is folded and housed in the cell case 1, the ribs 7D on the short side faces 7H wrap around into the cutaway parts of the long side faces 7G, and housing is carried out without any overlap between the two. In cases where, due to an overlap therebetween within the cell case 1, extra thickness becomes necessary for the cell, thereby presenting an obstacle to making it thinner, or in cases where heat conductivity (heat releasability) within the cell drops due to an overlap therebetween and becomes a problem, a solution may be reached by adopting such an arrangement as that mentioned above.

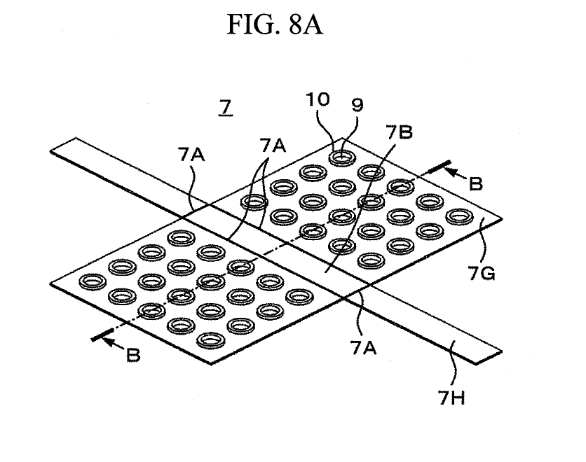

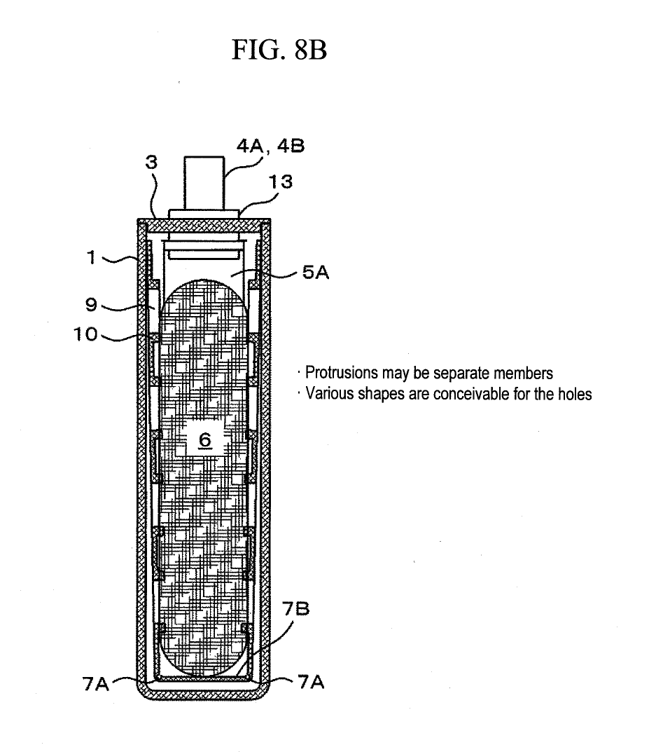

Next, FIG. 8A is a perspective view of the insulation cover 7 of the seventh embodiment, and FIG. 7B is a sectional view taken along line B-B showing its shape as housed in the cell case 1.

In the present embodiment, a plurality of through-holes 9 are formed in the faces of the insulation cover 7 that face the coated part 6F of the electrode assembly 6 (i.e., the long side faces 7G). Further, around each of the through-holes 9 and on the side closer to the power-generating element is formed a protruding thick part 10. As can be seen from FIG. 8B, once the insulation cover 7 is folded and housed in the cell case 1, the thick parts 10 exert pressure on the electrode assembly 6 (in order to represent this aspect in a manner that is easy to understand, in FIG. 8B, the thick parts 10 and the electrode assembly 6 are shown to partially intersect each other). Here, each of the through-holes 9 enables communication of the electrolyte between the insulation cover 7 and the cell case 1 as well as between the insulation cover 7 and the electrode assembly 6, and reduces free fluids that do not directly affect cell functions. On the other hand, the thick parts 10 exert an appropriate surface pressure with respect to the electrode assembly 6. The thick parts 10 and the insulation cover 7 are made of the same material, the material being a flexible resin material. Thus, even if the gap between the cell case 1 and the electrode assembly 6 were to vary, they are able to exist between the two while conforming to that gap. Consequently, as an appropriate surface pressure is exerted on the electrode assembly 6, inevitable gaps that occur between the layers and reduce cell efficiency are squashed together and mitigated, thereby making it possible to keep cell efficiency high. Further, even if the thickness of the electrode assembly 6 were to inevitably vary, this can be absorbed by way of the flexibility of the thick parts 10.

It is noted that although lithium ion secondary cells have been provided above as examples of a cell, the present invention is by no means limited thereto, and is applicable to secondary cells in general. Further, while lithium manganate and graphite have been provided as examples of a positive electrode active material and a negative electrode active material, respectively, the present invention is by no means limited thereto, and any active material ordinarily used in lithium ion secondary cells may be used as well. For the positive electrode active material, a lithium transition metal complex oxide, which is a material that allows for lithium ion insertion and extraction and in which a sufficient amount of lithium ions are inserted in advance, may be used, and a material in which a portion of the lithium or transition metal within the lithium transition metal complex oxide crystal is replaced or doped with some other element may be used as well. Further, there is no particular limitation with respect to the crystal structure either, whether it be a spinel structure, a layered structure, or an olivine structure. On the other hand, examples of negative electrode active materials besides graphite may include carbon materials such as, for example, coke, amorphous carbon, etc. Again, there is no particular limitation with respect to the particle shape thereof, whether it be scale-like, spherical, fibrous, lump-like, etc.

Further, the present invention is by no means limited to the electrically conductive materials and binders provided in the embodiments by way of example, and any electrically conductive material or binder ordinarily used in lithium ion secondary cells may be used. Binders that may be used, besides those in the embodiments above, may include such polymers as polytetrafluoroethylene, polyethylene, polystyrene, polybutadiene, butyl rubber, nitrile rubber, styrene/butadiene rubber, polysulfide rubber, nitrocellulose, cyanoethyl cellulose, various latexes, acrylonitrile, vinyl fluoride, vinylidene fluoride, propylene fluoride, chloroprene fluoride, etc., as well as mixtures thereof, etc.

Further, while, in the embodiments above, a nonaqueous electrolyte in which LiPF₆ is dissolved in a carbonate ester organic solvent such as ethylene carbonate, etc., has been provided as an example, it is also possible to use a nonaqueous electrolyte in which a common lithium salt is taken to be an electrolyte and this is dissolved in an organic solvent, and the present invention is thus by no means limited to any particular lithium salt or organic solvent. For the electrolyte, LiClO₄, LiAsF₆, LiBF₄, LiB(C₆H₅)₄, CH₃SO₃L₁, CF₃SO₃Li, etc., as well as mixtures thereof, may be used, for example. Further, diethyl carbonate, propylene carbonate, 1,2-diethoxyethane, γ-butyrolactone, sulfolane, propionitrile, etc., or a mixed solvent in which two or more of the above are mixed may be used for the organic solvent.

Further, while, in the embodiments above, an example has been provided where the electrode assembly 6 is formed by spirally winding the positive plate 6E and the negative plate 6D, the present invention is by no means limited thereto. For example, it is also possible to form the electrode assembly 6 by providing the positive plate 6E and the negative plate 6D in layers. As shown in FIG. 10, in a layered electrode assembly 6, rectangular positive plates 6E and rectangular negative plates 6D are alternately layered with rectangular separators 6C provided therebetween. In so doing, they are layered in such a manner that the uncoated parts 6A and the uncoated parts 6B are respectively positioned at opposite end faces of the electrode assembly 6. It is possible to attain similar effects as those of the embodiments described above with such a layered power-generating element array 6 as well.

Further, instead of being separate parts, the seal members 13 may be formed through insert molding as well. Using a mold that holds the cell case 1, the external terminal 4A, and the external terminal 4B at certain intervals, the seal members 13 may be formed by insert molding such resin materials as PPS, PBT, etc., in the gap formed in the mold. Through insert molding, the relative positions of the cell lid 3, and the external terminals 4A, 4B are fixed, insulation therebetween is established, and airtightness is established.

### DESCRIPTION OF SYMBOLS

1 Cell case
3 Cell lid
4A External terminal (positive electrode)
4B External terminal (negative electrode)
5A Connection plate (positive electrode)
5B Connection plate (negative electrode)
6 Electrode assembly
6A Uncoated part (positive electrode)
6B Uncoated part (negative electrode)
6C Separator
6D Negative plate
6E Positive plate
6F Coated part
7 Insulation cover
7A Thin part
7B Bottom face
7C Bump/dent part
7D Rib
7G Long side face
7H Short side face
8A Joint (positive electrode)
8B Joint (negative electrode)
9 Through-hole
10 Thick part
11 Open face
13 Seal member
20 Filling port
22 Filling plug

What is claimed is:

1. A secondary cell comprising:
a cell case of a rectangular cuboid shape having an opening;
a cell lid configured to seal the opening in the cell case;
an electrode assembly provided in a space defined by the cell case and the cell lid; and
an insulation cover configured to electrically insulate between the cell case and the electrode assembly, wherein
the insulation cover comprises:
a bottom face part facing the opening in the cell case and having four sides;
side face parts formed along at least two opposite sides of the four sides of the bottom face part; and
bend parts provided in such a manner that boundaries between the bottom face part and the side face parts bend as the electrode assembly is inserted into the cell case.

2. A secondary cell according to claim 1, wherein the insulation cover comprises linear thin parts for defining the bend parts.

3. A secondary cell according to claim 2, wherein the thin parts are formed by having a portion of a face facing the electrode assembly be recessed.

4. A secondary cell according to claim 1, wherein, with respect to the insulation cover, the bottom face part is higher in flexural rigidity than the other parts.

5. A secondary cell according to claim 1, wherein, with respect to the insulation cover, the bottom face part is higher in flexural rigidity than the other parts due to the fact that the bottom face part is thicker than the side face parts.

6. A secondary cell according to claim 1, wherein, with respect to the insulation cover, the bottom face part is higher in flexural rigidity than the other parts due to the fact that the bottom face part has a bump/dent surface.

7. A secondary cell according to claim 1, further comprising a wall generally perpendicular to the side face parts on a portion of the side face parts, wherein the wall is present between the side face parts and the cell case.

8. A secondary cell according to claim 1, wherein a through-hole is provided in a portion of the side face parts.

9. A secondary cell according to claim 1, further comprising a part that protrudes towards the electrode assembly on a portion of the side face parts.

10. A method of producing a secondary cell, the secondary cell comprising:
a cell case of a rectangular cuboid shape having an opening;
a cell lid configured to seal the opening in the cell case;
an electrode assembly provided in a space defined by the cell case and the cell lid; and
an insulation cover configured to electrically insulate between the cell case and the electrode assembly, the insulation cover comprising: a bottom face part facing the opening in the cell case and having four sides; and side face parts formed along at least two opposite sides of the four sides of the bottom face part, wherein
the method comprises a step in which the electrode assembly presses the insulation cover, as a result of which boundaries between the bottom face part and the side face parts bend, and the electrode assembly is housed in the cell case along with the insulation cover.
